(19) United States
(12) Patent Application Publication
(10) Pub. No.: US 2004/0020123 A1
(43) Pub. Date: Feb. 5, 2004

(54) Dewatering device and method for gas hydrate slurrys

(76) Inventors: Takahiro Kimura, Kobe-shi (JP); Shojiro Iwasaki, Kobe-shi (JP); Katsuo Itoh, Kobe-shi (JP); Yuichi Kondo, Kobe-shi (JP); Kozo Yoshikawa, Takasago-shi (JP); Hiromitsu Nagayasu, Takasago-shi (JP); Haruhiko Ema, Takasago-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/416,004

(22) PCT Filed: Aug. 29, 2002
(86) PCT No.: PCT/JP02/08724

(30) Foreign Application Priority Data
Aug. 31, 2001 (JP) 2001-264907

(51) Int. Cl. C01B 3/32

(52) U.S. Cl. 48/127.3

(57) ABSTRACT

It is required to provide a gas hydrate dewatering device which performs dewatering and produces a gas hydrate with a low proportion of included water continuously at high efficiency, under conditions in which the gas hydrate is not decomposed and the water is not frozen into ice. This is achieved by providing a dewatering device (12) for gas hydrate slurry which eliminates the water from a slurry in which gas hydrate is dispersed in water, including a dewatering mechanism of a screw press type within an environment which is maintained at temperature and pressure conditions at which the gas hydrate does not decompose and the water does not freeze.

### TECHNICAL FIELD

The present invention relates to a dewatering device and a dewatering method for a gas hydrate slurry, which eliminate water from a slurry consisting of a gas hydrate (a hydrate material) which has been formed by contacting together a raw material gas and water, which is dispersed in water.

### BACKGROUND ART

At present, as a method for storing and transporting natural gas whose principal component is a hydrocarbon such as methane or the like, the method is in general use of, after collecting the natural gas from the gas field, cooling it to a temperature at which it liquefies, so that it is stored and transported in the liquid state as so called liquid natural gas (LNG). However, in the case for example of methane, which is a principle component of a liquefied natural gas, it is necessary to cool the natural gas to the extremely low temperature region of −162° C. in order to liquefy it, and to maintain this condition while the liquefied natural gas is being stored and transported, which means that it is necessary to provide special devices for storing and special means for transporting such LNG. Since the cost required for production, maintenance, and operation of such specialized devices and the like is extremely high, various researches have been performed with the objective of developing a low cost natural gas storage and transportation method, instead of the above described high cost method of liquefaction by cooling.

As a result of this type of research, a method has been proposed of hydrating the natural gas to produce a hydrated material in the solid state (in the following termed a “natural gas hydrate”), and of storing and transporting this solid state hydrated material, and this method has appeared particularly promising in recent years. With this method it is not necessary to attain extremely low temperature conditions such as are required in order to handle LNG, and it is comparatively easy to handle it in the solid state. Due to this, it becomes possible to take advantage of somewhat improved versions of currently existing freezing devices and currently existing container ships as storage devices and transport means for natural gas, and accordingly it is possible to anticipate a great reduction in cost.

One type of such natural gas hydrate is a so called inclusion compound or clathrate compound, and there are such compounds which form crystalline structures by including the molecules which are the components of natural gas, in other words methane (CH₄), ethane (C₂H₆), and propane (C₃H₈) and the like in inclusion lattices (clathrates) of solid basket form made up from a plurality of water molecules (H₂O). The distance between each of the molecules in a clathrate in which natural gas molecules are included becomes shorter, than the intermolecular distance in a gas cylinder when the natural gas is filled into the cylinder at high pressure. This means that it is possible to generate a solid densely charged with natural gas; for example, under the pressure and temperature conditions in which the hydrate of methane can exist in stable form, which are −30° C. and atmospheric pressure (1 kg/cm²), it is possible to reduce the volume by a factor of about 1/170 as compared with the gaseous state. In this manner, it is possible to manufacture natural gas hydrate comparatively easily under appropriate temperature and pressure conditions, and moreover to store it stably.

With this method, the natural gas which has been produced from a gas field is subjected to a process of acidic gas elimination in which the acidic gases such as carbon dioxide (CO₂) and hydrogen sulfide (H₂S) are eliminated, and, after having been temporarily stored in a gas storage section in the low temperature and high pressure state, is hydrated in a hydrate generation process. The resulting natural gas hydrate is in slurry form mixed with water (hereinafter termed “raw material slurry”), and next is subjected to a dewatering process, in which the remaining water after the reaction which is mixed with the raw material slurry is eliminated; and the resulting substance is passed through a cooling process and a pressure reduction process, so as to result in a solid substance which can be loaded into a vessel such as a container or the like, and which can be stored in the state in which its temperature and pressure are adjusted to predetermined values.

During transportation, this vessel is loaded onto a transport means such as a container ship or the like just as it is, and is transported to the target location. After having been unloaded at the target location, the hydrate substance is subjected to a decomposition process so as to return the natural gas to the gaseous state, and the gas is then supplied to each location where it is required.

It should be understood that, apart from the above described natural gas hydrate, it is possible to generate various other types of gas hydrate by changing the raw material gas.

However, with the above described prior art process from generation of the gas hydrate to transport thereof, there are the following problems which must be resolved. That is to say, since the gas hydrate directly after generation in the gas hydrate generation plant is in the form of a slurry which contains a large amount of water (water slurry), therefore, if this gas hydrate is to be stored and transported in this state or after having been cooled, the cost required for its storage and transportation becomes undesirably increased, since its volume and weight are increased by the water (ice) component. In other words, if the gas hydrate in slurry form (the raw material slurry) including a large amount of water is cooled so that it can be transported in solid form, the gas density becomes low, and a large quantity of surplus water (ice) is transported at the same time as the natural gas itself, so that the transportation efficiency is poor, which is not desirable.

In particular, in the case of a natural gas hydrate in which natural gas is the raw material, in order to ensure a high recovery rate, it is desirable to perform dewatering under conditions in which the natural gas hydrate does not decompose and the water does not freeze, and accordingly it is desirable to perform the dewatering while maintaining high pressure conditions. Furthermore, it is very important perfectly to prevent all leakage to the exterior of the dewatering device, since the natural gas is inflammable.

### DISCLOSURE OF INVENTION

The present invention has been conceived in consideration of the above described problems, and its objective is to propose a gas hydrate slurry dewatering device and slurry dewatering method which can offer a gas hydrate with a low proportion of included water by dewatering it continuously at good efficiency, under conditions such that the gas hydrate does not decompose and the water does not freeze into ice.

The present invention attains the above describe objective and resolves the above described problems by utilizing the following means.

A first aspect of the present invention is a dewatering device for a gas hydrate slurry which eliminates water from a slurry in which a gas hydrate is dispersed in water, in which a dewatering part is provided in an environment which is maintained at temperature and pressure conditions at which the gas hydrate does not decompose and the water does not freeze.

Since, according to this type of dewatering device for a gas hydrate slurry, the dewatering part is provided in an environment which is maintained at temperature and pressure conditions at which the gas hydrate does not decompose and the water does not freeze, thereby it becomes possible to perform dewatering easily without decomposing the gas hydrate, and while maintaining the water in the liquid phase.

A second aspect of the present invention is a dewatering device for a gas hydrate slurry which eliminates water from a slurry in which a gas hydrate is dispersed in water, in which a dewatering part is provided in a pressure vessel which is maintained at a temperature and a pressure at which the gas hydrate does not decompose and the water does not freeze.

Since, according to this type of dewatering device for a gas hydrate slurry, the dewatering part is provided within the pressure vessel which is maintained at temperature and pressure conditions at which the gas hydrate does not decompose and the water does not freeze, thereby it becomes possible to perform dewatering easily without decomposing the gas hydrate, and while maintaining the water in the liquid phase.

In this case, it is desirable for the dewatering part to be of a screw press type which can perform dewatering continuously.

Furthermore, by providing the drive section of said dewatering part within the pressure vessel, it becomes possible to transmit the drive power for the dewatering part without any requirement to pierce through the pressure vessel, so that no axial sealing structure is required. Such an axial seal can easily be the cause of leaks from the inside of the pressure vessel, and thus, by ensuring that no axial seal is required, it becomes possible to reduce the possibility of leakage of the liquid within the pressure vessel to the minimum possible level.

In particular, if the dewatering part is driven by a canned motor, it becomes possible easily to dispense with any such axial sealing structure.

And this dewatering device for a gas hydrate slurry as described above is particularly well adapted as a dewatering device for a natural gas hydrate slurry.

A third aspect of the present invention is a dewatering method for gas hydrate slurry which eliminates water from a slurry in which a gas hydrate is dispersed in water, in which said slurry in which a gas hydrate is dispersed in water is supplied to a dewatering part which is provided in an environment which is maintained at temperature and pressure conditions at which the gas hydrate does not decompose and the water does not freeze, and is dewatered thereby.

Since, according to this type of dewatering method for a gas hydrate slurry, a method is employed in which the slurry in which the gas hydrate is dispersed in water is supplied to and is dewatered by the dewatering part which is provided in an environment which is maintained at temperature and pressure conditions at which the gas hydrate does not decompose and the water does not freeze, thereby it becomes possible easily to perform dewatering without decomposing the gas hydrate, and while maintaining the water in the liquid phase.

A fourth aspect of the present invention is a dewatering method for gas hydrate slurry which eliminates water from a slurry in which a gas hydra-e is dispersed in water, in which a dewatering part is provided in a pressure vessel which is maintained at a temperature and a pressure at which the gas hydrate does not decompose and the water does not freeze, and said slurry in which a gas hydrate is dispersed in water is supplied to said dewatering part and is dewatered thereby.

Since, according to this type of dewatering method for a gas hydrate slurry, a method is employed in which the slurry in which the gas hydrate is dispersed in water is supplied to and is dewatered by the dewatering part which is provided within the pressure vessel which is maintained at temperature and pressure conditions at which the gas hydrate does not decompose and the water does not freeze, thereby it becomes possible to perform dewatering easily without decomposing the gas hydrate, and while maintaining the water in the liquid phase.

In this case, it is desirable for the dewatering part to be of a screw press type which can perform dewatering continuously. Furthermore, by providing the drive section of said dewatering part within the pressure vessel, it becomes possible to transmit the drive power for the dewatering part without any requirement to pierce through the pressure vessel, so that no axial sealing structure is required. Such an axial seal can easily be the cause of leaks from the inside of the pressure vessel, and thus, by ensuring that no axial seal is required, it becomes possible to reduce the possibility of leakage of the liquid within the pressure vessel to the minimum possible level.

In particular, if the dewatering part is driven by a canned motor, it becomes possible easily to dispense with any such axial sealing structure. And this dewatering device for a gas hydrate slurry as described above is particularly well adapted as a dewatering device for a natural gas hydrate slurry.

### BRIEF DESCRIPTION OF DRAWINGS

FIG. 1 is a block diagram showing an example of the structure of a process of a natural gas hydrate production system which is an embodiment of the present invention.

FIG. 2 is a figure showing the concrete structure of a device of the FIG. 1 natural gas hydrate generation system.

FIG. 3 is a structural diagram showing an embodiment of a dewatering device for a gas hydrate slurry according to the present invention.

FIG. 4 is a block diagram showing a process of a natural gas hydrate production system to which the dewatering device for a gas hydrate slurry according to the present invention can be applied (a first variant embodiment).

FIG. 5 is a block diagram showing a process of a natural gas hydrate production system to which the dewatering device for a gas hydrate slurry according to the present invention can be applied (a second variant embodiment).

FIG. 6 is a block diagram showing a process of a natural gas hydrate production system to which the dewatering device for a gas hydrate slurry according to the present invention can be applied (a third variant embodiment).

FIG. 7 is a block diagram showing a process of a natural gas hydrate production system to which the dewatering device for a gas hydrate slurry according to the present invention can be applied (a fourth variant embodiment).

FIG. 8 is a block diagram showing a process of a natural gas hydrate production system to which the dewatering device for a gas hydrate slurry according to the present invention can be applied (a fifth variant embodiment).

FIG. 9 is a block diagram showing a process of a natural gas hydrate production system to which the dewatering device for a gas hydrate slurry according to the present invention can be applied (a sixth variant embodiment).

FIG. 10 is a block diagram showing a process of a natural gas hydrate production system to which the dewatering device for a gas hydrate slurry according to the present invention can be applied (a seventh variant embodiment).

FIG. 11 is a block diagram showing a process of a natural gas hydrate production system to which the dewatering device for a gas hydrate slurry according to the present invention can be applied (an eighth variant embodiment).

### BEST MODE FOR CARRYING OUT THE INVENTION

In the following, preferred embodiments of the dewaterinq method and the dewatering device for a gas hydrate slurry according to the present invention will be explained with reference to the drawings. It should be understood that, in the embodiments described below, the explanation has been made in terms of the case in which the gas hydrate is a natural gas hydrate which takes natural gas as its raw material.

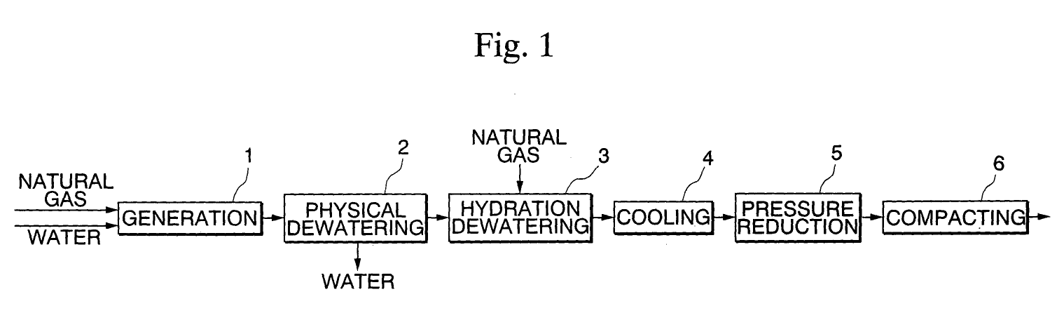

FIG. 1 is a block diagram showing the process flow of a production system for natural gas hydrate, to which the dewatering device for gas hydrate slurry and the slurry dewatering method according to the present invention are applied.

In this figure, the reference numeral 1 denotes a generation part which generates a natural gas hydrate by reacting together natural gas and water at a temperature higher than the freezing point of water and at a pressure higher than atmospheric pressure; the reference numeral 2 denotes a physical dewatering part which physically dewaters this natural gas hydrate which has been generated; the reference numeral 3 denotes a hydrate dewatering part which generates natural gas hydrate by reacting the remaining water which is included in the above natural gas hydrate with natural gas, in the dewatering process or after dewatering; the reference numeral 4 denotes a cooling part which cools the natural gas hydrate which has been generated; the reference numeral 5 denotes a pressure reduction part which reduces the pressure upon the cooled natural gas hydrate to atmospheric pressure; and the reference numeral 6 denotes a compacting part which compacts the cooled natural gas hydrate into a solid.

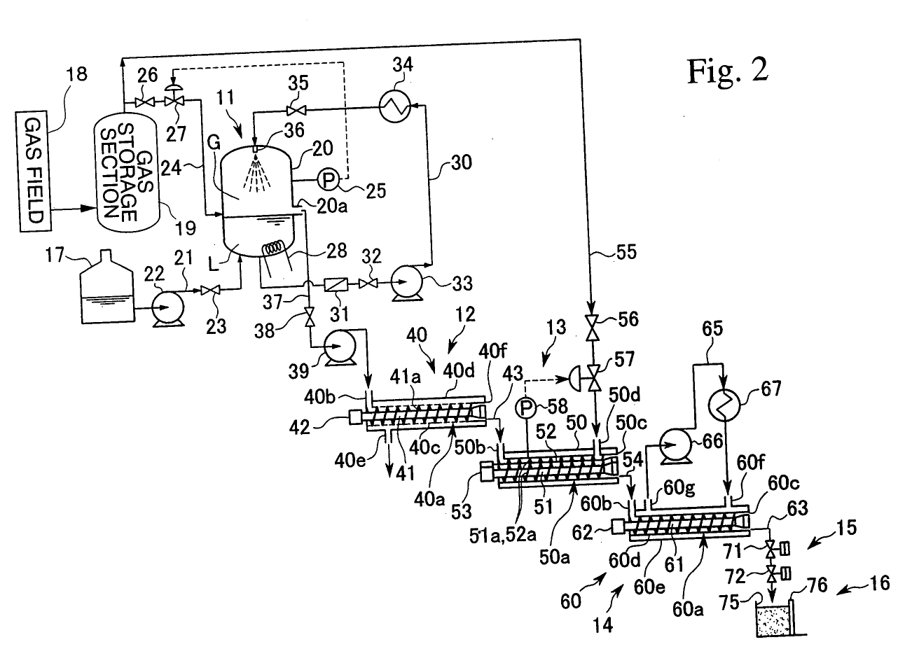

The concrete device structure of this production system is shown in FIG. 2. In this figure, the reference symbol 11 denotes a generation reaction device which constitutes the generation part 1; the reference symbol 12 denotes a screw press type dewatering device, which is a dewatering device for the gas slurry which constitutes the physical dewatering part 12; the reference symbol 13 denotes a double axis screw type dewatering device which constitutes the hydrate dewatering part 3; the reference symbol 14 denotes a screw conveyor type cooling device which constitutes the cooling part 4; the reference symbol 15 denotes a valve changeover type pressure reduction device which constitutes the pressure reduction part 15; and the reference symbol 16 denotes a pressure application press type compacting device (a gas hydrate compacting device) which constitutes the compacting part 6. Furthermore, the reference numeral 17 denotes a water storage tank which stores water which is a raw material; the reference numeral 18 denotes a gas field which produces natural gas which similarly is a raw material; and the reference numeral 19 denotes a gas storage section which stores the natural gas which has been produced from this gas field 18.

The generation reaction device 11 comprises a pressure vessel 20 which is hermetically sealed. The water storage tank 17 is connected to the pressure vessel 20 via a water distribution conduit 21, and a quantity of water L is built up in the interior of the pressure vessel 20 by supplying water thereinto from the water storage tank 17 through the water distribution conduit 21. Furthermore, a water supply pump 22 and a valve 23 are provided in the water distribution conduit 21, and the quantity of water L is controlled so as to maintain a predetermined water level.

Furthermore, the gas storage section 19 is connected to the pressure vessel 20 via a gas distribution conduit 24. The natural gas which has been produced from the gas field 18 is stored by a compressor or the like in the gas storage section 19 in the low temperature and high pressure state, after a process of elimination of acidic gas and heavy constituents has been completed. A quantity G of natural gas is built up in the interior of the pressure vessel 20 by supplying the natural gas which has been stored in the gas storage section 19 thereinto via the gas distribution conduit 24.

Further, a pressure sensor 25 is provided within the pressure vessel 20 for measuring the pressure of the gas mass G, and a valve 26 and a flow amount adjustment valve 27 are provided in the gas distribution conduit 24; and, based upon the value measured by the pressure sensor 25, the opening amount of the flow amount adjustment valve 27 is controlled so as, by adding natural gas to the interior of the pressure vessel 20, to keep the pressure of the gas mass G at the generation pressure of the gas hydrate (for example 40 atm).

And a cooling device 28 provided within the pressure vessel 20 keeps the temperature of the water mass L at a lower temperature than the generation temperature (for example about 5° C.) of gas hydrate, which is a temperature higher than the freezing point of water (this state will be defined as the “supercooled” state). This maintenance of the supercooled state by the cooling device 28 is in order to recover the heat of hydration which is generated by the process of generating the natural gas hydrate, so as to keep the interior of the generation reaction device 11 always at the generation temperature. It should be understood that, for the cooling device 28, it is desirable o utilize a cooling coil or radiator which directly cools the mass of water L, or a cooling jacket which surrounds the pressure vessel 20 and cools it in its entirety.

A water distribution conduit 30 is connected to the pressure vessel 20 so as to connect its top portion to its bottom portion. In this water distribution conduit 30 there are provided a filter 31, a valve 32, a water recirculation pump 33, a heat exchanger 34, and a valve 35. Furthermore, a spray nozzle 36 is provided at the tip end of the water distribution conduit 30, so as to project from the top portion of the pressure vessel 20 into its interior.

A slurry extraction aperture 20a is provided upon the side face of the pressure vessel 20 close to the liquid surface of the mass L of water, for extracting the natural gas hydrate in slurry form which has been formed at that liquid surface. This slurry extraction aperture 20a is connected to the screw press type dewatering device 12 via a slurry distribution conduit 37. A valve 38 and a slurry extraction pump 39 are provided in the slurry distribution conduit 37, and thereby the natural gas hydrate which is formed at the liquid surface of the mass L of water is extracted and is supplied to the screw press type dewatering device 12.

The screw press type dewatering device 12 comprises a vessel main body 40 which has an interior space 40a of cylindrical shape, a filter member 40c shaped as a tubular screen (mesh) which is provided in the interior of the vessel main body 40, a screw portion 41 which is an axially extending body provided in the interior space 40a and having on its side surface a projecting portion 41a of helical form, and a drive section 42 which drives this screw portion 41.

At the end of the vessel main body 40 at its upstream side there is provided a raw material slurry feed in aperture 40b, through which the natural gas hydrate formed as slurry in the generation reaction device 11 (the raw material slurry) from the upward direction is fed into the interior space 40a. The above described slurry distribution conduit 37 is connected to this raw material slurry feed in aperture 40b. The vessel main body 40 has a double layered structure consisting of a filter member (inner wall) 40c which defines its interior space 40a, and a supporting casing 40d which constitutes its outer shell; and the filter member 40c functions as a mesh, while in the lower portion of the supporting case 40d there is provided a recovered water ejection aperture 40e through which the water which accumulates in the interior due to dewatering (the recovered water) is ejected.

Along with the screw portion 41 being arranged with the outer circumferential rotational surface of its projecting helical portion 41a closely touching against the inner surface of the interior space 40a, in other words against the filter member 40c, it is supported so as to be rotatable around its own axial line in a predetermined direction, and is rotationally driven by the drive section 42 which is connected to its axial end.

At the final end of the vessel main body 40 at its downstream side there is provided a hydrate ejection aperture 40f, through which the natural gas hydrate which has been conveyed thereto by the rotation of the screw portion 41 is ejected. This hydrate ejection aperture 40f is connected to the next stage double axis screw type dewatering device 13 via a hydrate distribution conduit 43.

In the following, the characteristic structure of the present invention will be described in detail with reference to the above described screw press type dewatering device (dewatering device for gas hydrate slurry) 12.

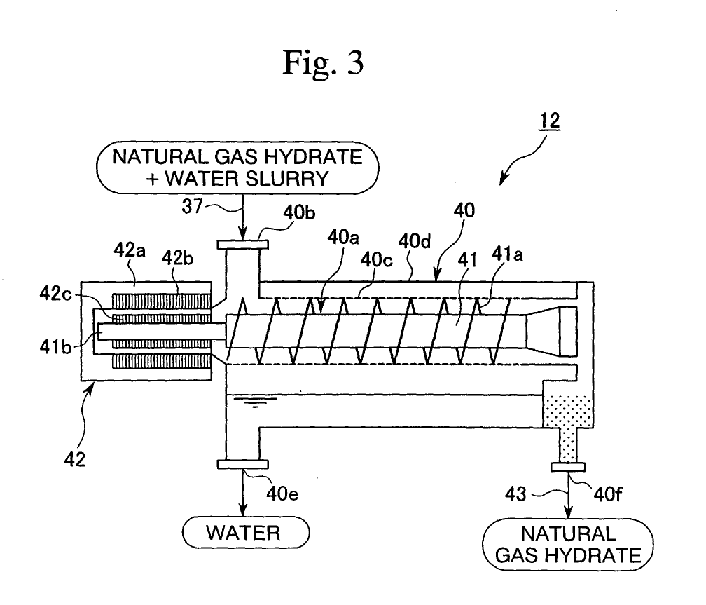

FIG. 3 is one which shows the screw press type dewatering device 12 of FIG. 2 in magnified view, for explanation of its detailed structure.

It should be understood that, with this screw press type dewatering device 12, since the raw material slurry which is to be dewatered is natural gas hydrate, therefore in order, along with maintaining its recovery factor, also to obtain an end product with a low ratio of included water, the dewatering must be performed under conditions in which the natural gas hydrate does not decompose and the water does not freeze. Due to this, it is necessary to perform the dewatering in an environment which is maintained at high pressure conditions with the pressure greater than or equal to 0.5 MPa. Moreover, at this time, the temperature must be greater than 0° C.

Thus, the vessel main body 40 of the screw press type dewatering device 12 constitutes a pressure vessel which can endure the above described high pressure conditions, and the screw press type dewatering mechanism is set up in its interior. In concrete terms, its casing 40d which is its external case constitutes the pressure vessel, and the screw portion 41 which uses a canned motor in the drive section 42 is employed.

The canned motor which constitutes the drive section 42 comprises a fixed side body coil 42b mounted upon the inner wall surface of the outer wall portion 42a which constitutes one section of the casing 40d, while a rotating side rotor coil 42c is provided upon an axially tip portion 41b which extends from the axial portion of the screw portion 41. It should be understood that a space is maintained between the body coil 42b and the rotor coil 42c so that they do not contact one another.

Since this type of structure is utilized, upon the passage of electric current, the rotor portion coil 42c rotates with respect to the body coil 42b which is fixed to the outer wall portion 42a, together with the screw portion 41 which is coaxial therewith. Due to this, the screw portion 41 and the drive section 42 so to speak seal the rotating axis portion which pierces through the casing 40d of the pressure vessel, and constitute an installation in which no troublesome seal structure is required. In particular, since leakage of the natural gas (which is an inflammable gas) from the pierced portion through which the rotational shaft passes to the outside of the vessel main body 40 must absolutely be avoided, the use of a canned motor in which no perfect seal structure is required for the shaft pierced portion is desirable from this point of view as well.

The natural gas hydrate which has been dewatered with the above described screw press type dewatering device 12 is fed to the double axis screw type dewatering device 13.

The double axis screw type dewatering device 13 comprises a vessel main body 50 which has a tubular shaped interior space 50a having an elliptical cross section, and two axially extending bodies 51 and 52 disposed within this interior space 50a having on their side surfaces projecting portions 51a and 52a of helical form, which individually rotate so as to transport the natural gas hydrate.

At the end of the vessel main body 50 there is provided a feed in aperture 50b, through which the natural gas hydrate which has been physically dewatered by the screw press type dewatering device 12 is fed in. The above described hydrate distribution conduit 43 is connected to this feed in aperture 50b.

The axially extending bodies 51 and 52 are arranged so as to be mutually parallel and are also disposed so that, as seen from the axial direction, their respective projecting portions 51a and 52a overlap. Furthermore, along with these projecting portions 51a and 52a being arranged so as to closely touch against the inner wall surface of the interior space 50a, they are supported so as to be capable of rotation about their own axes, and they are rotationally driven by a drive section 53. It should be understood that it would be acceptable for the directions in which these two axially extending bodies rotate to be the same, or to be opposite.

At the final end of the vessel main body 50 at its downstream side there is provided an ejection aperture 50c, through which the gas hydrate which has been conveyed thereto by the rotation of the axially extending bodies 51 and 52 is ejected. This ejection aperture 50c is connected to the next stage screw conveyor type cooling device 14 via a hydrate distribution conduit 54.

A gas supply orifice 50d is provided in the side surface of the vessel main body 50 close to the ejection aperture 50c, for supplying natural gas to the interior space 50a. This gas supply orifice 50d is connected to a gas storage section 19 via a gas distribution conduit 55 which branches off from the gas distribution conduit 24. A valve 56 and a flow amount adjustment valve 57 are provided in this gas distribution conduit 55.

On the other hand, a pressure sensor 58 is arranged in the vessel main body 50 close to the feed in aperture 50b so as to detect the pressure in the interior space 50a, and the opening amount of the flow amount adjustment valve 57 is controlled, based upon the value measured by the pressure sensor 58, so as, by adding natural gas into the interior space 50a, to maintain the pressure in said interior space 50a at the generation pressure (for example 40 atm).

Cooling devices (not shown in the figure) are provided to the screw press type dewatering device 12 and the double axis screw type dewatering device 13, and these maintain the interiors of the vessel main bodies 40 and 50 in the above described supercooled state.

The screw conveyor type cooling device 14 comprises a vessel main body 60 which has an interior space 60a of cylindrical shape, and an axially extending body 61 which is arranged within the interior space 60a and has on its side surfaces a projecting portion 61a of helical form.

At the end of the vessel main body 60 there is provided an intake aperture 60b, through which the natural gas hydrate which has been subjected to hydrate dewatering by the double axis screw type dewatering device 13 is taken into the interior space 60a. The above described hydrate distribution conduit 54 is connected to this intake aperture 60b.

Along with the axially extending body 61 being arranged so that its projecting portion 61a closely touches against the inner wall surface of the interior space 60a, it is supported so as to be capable of rotation about its own axis in a predetermined rotational direction, and it is rotationally driven by a drive section 62.

At the final end of the vessel main body 60 at its downstream side there is provided an ejection aperture 60c, through which the natural gas hydrate which has been conveyed thereto by the rotation of -he axially extending body 61 is ejected. This ejection aperture 60c is connected to the next stage valve changeover type pressure reduction device 15 via a hydrate distribution conduit 63.

The vessel main body 60 has a double layered structure consisting of an inner wall 60d which defines its interior space 60a and a casing 60e, and in the side surface of the casing 60e near the ejection aperture 60c there is provided a cooling medium intake aperture 60f through which a cooling medium is introduced into the gap between said casing 60e and the inner wall 60d, while a cooling medium ejection aperture 60g is provided in the side wall of the casing 60e near the intake aperture 60b for ejection of said cooling medium.

A cooling medium distribution conduit 65 is connected between the cooling medium intake aperture 60f and the cooling medium ejection aperture 60g, and a cooling medium recirculation pump 66 and a heat exchanger 67 are provided in this cooling medium distribution conduit 65. The cooling medium is cooled by the heat exchanger 66, flows through the cooling medium distribution conduit 65 into the gap between the inner wall 60d and the casing 60e, and cools the natural gas hydrate for which the dewatering process has been completed to a low temperature below the freezing point of water (for example −10° C. to −15° C.) at which said natural gas hydrate does not decompose even at low pressure.

The valve changeover type pressure reduction device 15 is made up of two valves 71 and 72 which are provided in series in the hydrate distribution conduit 63. The two valves 71 and 72 are arranged as somewhat separated, and the hydrate distribution conduit 63 is vented to the atmosphere through the later stage valve 72 with the pressure application press type compacting device 16 being provided thereafter. This pressure application press type compacting device 16 comprises a fixed wall surface 75 and a movable plate 76 which can be driven towards and away from the fixed wall surface 75.

The process of generation of natural gas hydrate using this production system whose structure has been described above will now be explained.

First, water is fed into the pressure vessel 2 from the water storage tank 17 so as to form the quantity of water L. At the same time, natural gas is fed into the pressure vessel 20 from the gas storage section 19, and the pressure of the resulting gas mass G is raised up to the generation pressure for gas hydrate. It should be understood that, if required, it would also be acceptable to add a quantity of stabilizing material to the water which is used for forming the quantity of water L. Next, the quantity of water L is cooled until its temperature drops to the supercooled state, and temperature management is subsequently performed so as to maintain it in the supercooled state thereafter.

While stabilizing the temperature and the pressure within the pressure vessel 20, a portion of the water which constitutes the mass of water L is extracted from the bottom of the pressure vessel 20 via the water distribution conduit 30, and, after having been subjected to the above described re-cooling by the heat exchanger 34, is sprayed out from the spray nozzle 36 into the gas mass G. The water particles which have been sprayed out from the spray nozzle 36 float through the gas mass G while drifting downwards towards the mass of water L. By forming a large quantity of particles of water within the gas mass G in this manner, the total area of these particles of water which are present within the gas mass G, in other words, the contact area of the water with the natural gas which constitutes the gas mass G, becomes extremely large. A hydration reaction between the water and the natural gas takes place at the surfaces of the water particles, and thereby natural gas hydrate is generated. It should be understood that, since the temperature within the pressure vessel 20 is controlled so as to be higher than the freezing point of water, accordingly the water which constitutes the mass L of water, and the water particles which have been sprayed in, do not freeze.

The natural gas hydrate which has been formed at the surfaces of the water particles falls down just as it is, and falls down to and accumulates upon the liquid surface of the quantity of water L, and forms a layer of natural gas hydrate. This natural gas hydrate is extracted through the slurry extraction aperture 20a, and is fed to the screw press type dewatering device 12 via the slurry distribution conduit 37. Since the natural gas hydrate is recovered along with water, the ratio of included water is very great, so that at this time the mixture constitutes a slurry.

The natural gas hydrate in the form of a slurry (the raw material slurry) which has been fed to the screw press type dewatering device 12 via the slurry distribution conduit 37 falls from the raw material slurry feed in aperture 40b into the interior space 40a within the vessel main body 40, and is accumulated therein. And it is transported in the axial direction by the rotation of the screw portion 41, and is subjected to physical dewatering by the application of pressure due to this transportation. Since at this time the pressure and the temperature within the vessel main body 40 within which the screw portion 41 is provided are maintained at suitably high levels, the natural gas hydrate is dewatered but is not subjected to decomposition. Furthermore, with regard to the water component, since it does not freeze and no ice is generated, thereby the slurry can be well dewatered and the resultant water can be collected at good efficiency in liquid form just as it is. Accordingly, the natural gas hydrate which has been properly generated by the previous process is not decomposed, and the efficiency by which it is collected is not deteriorated.

It should be understood that the water component which has been separated from the natural gas hydrate falls down through the meshes of the filter member 40c to the lower portion of the casing 40d and is collected, and is ejected from the recovered water ejection aperture 40e.

On the other hand, the natural gas hydrate after physical dewatering is ejected from this screw press type dewatering device 12 through the hydrate ejection aperture 40f, and is fed to the double axis screw type dewatering device 13 via the hydrate distribution conduit 43.

This natural gas hydrate which has been fed to the double axis screw type dewatering device 13 is supplied into its interior space 50a via the feed in aperture 50b, and is transported in the axial direction by the rotation of the axially extending bodies 51 and 52. By this process, the remaining water component therein and the natural gas which is supplied to the interior space 50a are brought into contact, and, along with this, by the remaining water component and the natural gas being cooled while being churned together, they are reacted together so as to generate a hydrate.

By the time that the natural gas hydrate which has been fed into the interior space 50a has arrived at the ejection aperture 50c, it has been subjected to dewatering by almost all the remaining water component which had been present therein having been subjected to a hydration reaction with the non hydrated natural gas, and, as a result, the quantity of natural gas hydrate therein is increased. The natural gas hydrate after this dewatering is ejected from this double axis type dewatering device 13 via the ejection aperture 50c, and is fed to the screw conveyor type cooling device 14 via the hydrate distribution conduit 54.

This natural gas hydrate which has been fed to the screw conveyor type cooling device 14 is supplied into its interior space 60a through the feed in aperture 60b, and is transported in its axial direction by the rotational operation of the axially extending body 41, and during this process it is cooled by the cooling medium which is recirculating in the interior of the vessel main body 60. The natural gas hydrate which has been cooled to a low temperature lower than the freezing point of water is ejected from the screw conveyor type cooling device 14 via the ejection aperture 60f thereof, and is fed to the valve changeover type pressure reduction device 15 via the hydrate distribution conduit 63.

This valve changeover type pressure reduction device 15 is put into its state in which the upstream side valve 71 is opened and the downstream side valve 72 is closed, and the natural gas hydrate is received thereinto. Since the natural gas hydrate accumulates between the valves 71 and 72, after some time the valve 71 is closed, and next the valve 72 is opened and the natural gas hydrate between the valves is subjected to pressure reduction to atmospheric pressure. After having completed this pressure reduction, the natural gas hydrate is ejected from the valve changeover type pressure reduction device 15, and is fed to the pressure application type compacting device 16.

This natural gas hydrate which has been fed to the pressure application press type compacting device 16 is compacted into a solid by the plate 76 being pressed toward the wall portion 75. And this natural gas hydrate which has been compacted into solid form is stored in a specialized transport vessel not shown in the figure, and after storage is then transported.

Since with the above described production system the natural gas and the water are reacted together at a temperature which is higher than the freezing point of water and at a pressure which is higher than atmospheric pressure, accordingly it is possible to generate natural gas hydrate without the water freezing. Moreover, since a large quantity of water is initially included in this natural gas hydrate, the natural gas hydrate which is generated is physically dewatered, and then after this physical dewatering the remaining water component which is included in this natural gas hydrate is reacted with natural gas so as to generate further natural gas hydrate, and thereby the ratio of included water in the final natural gas hydrate is reduced.

Since all of the processes up till this point have been performed at temperatures which are higher than the freezing point of water and at pressures which are higher than atmospheric pressure, and since it is necessary to eject the natural gas hydrate which is formed at atmospheric pressure and to cool it to a temperature which is lower than the freezing point of water, therefore the pressure reduction is performed after freezing the remaining water (ice), and then it is ejected at atmospheric pressure.

By performing the above processes, a natural gas hydrate is obtained which has a reduced included water ratio.

Accordingly, with the above described production system, it is possible to generate the natural gas hydrate with a low proportion of included water, and to reduce the cost for its storage and transportation. Furthermore, because the natural gas hydrate is compacted into a solid after the pressure reduction process, it is possible to enhance the level of convenience during its storage and transportation.

It should be noted that although, in this embodiment, the hydrate dewatering was performed after the independent physical dewatering by the screw press type dewatering device 12, it would also be acceptable to perform the hydrate dewatering as a simultaneous process with the physical dewatering. Furthermore, although in this embodiment the compacting part 6 (the pressure application press type compacting device 16) was provided at a stage after the pressure reduction part 5 (the valve changeover type pressure reduction device 15), it would also be possible not to provide any compacting part 6, but to put the natural gas hydrate after dewatering into a vessel just as it is and to store and transport it in that state.

Moreover, it would also be possible to utilize the above described screw press type dewatering device 12 in a different process than the production system shown in FIG. 1.

In the following, various examples of the structure of processes to which the above described screw press type dewatering device 12 can be applied will be described in a simple manner with reference to the figures. It should be understood that to structural elements which are the same as ones already explained with reference to the above described embodiment the same reference symbols will be affixed, and their description will be curtailed.

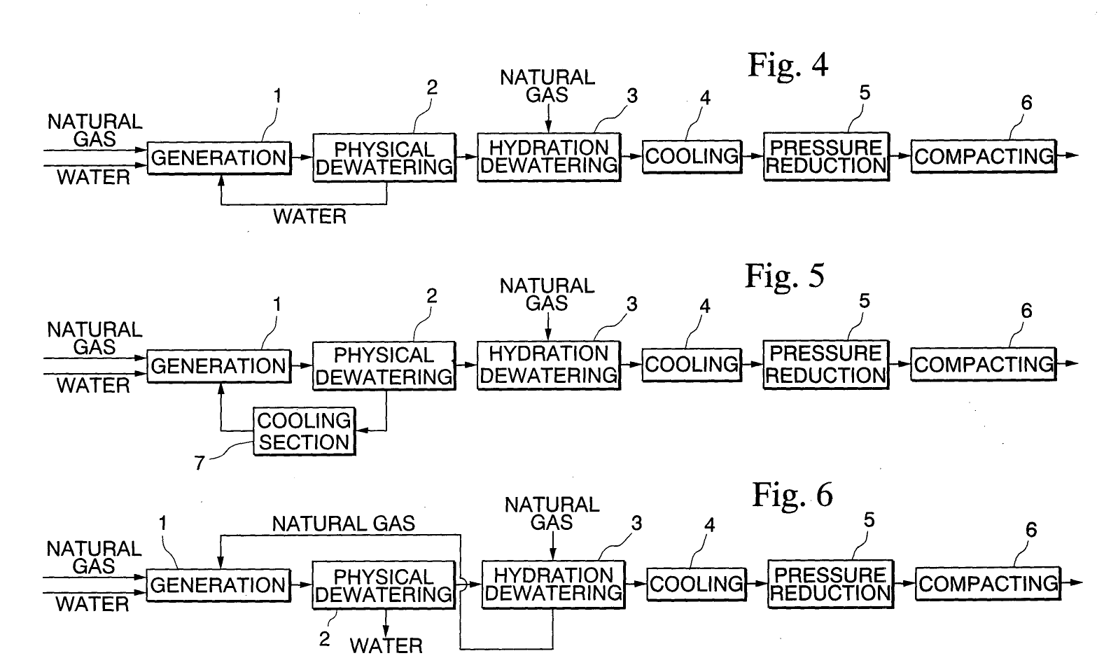

In the first variant embodiment, of which a structural block diagram of the processes thereof is shown in FIG. 4, the water which has been separated by the dewatering process is returned to the generation part 1 and is reused. In concrete terms, a structure is employed in which a water distribution conduit is provided which connects together the ejection aperture 40e of the screw press type dewatering device 12 and the water storage tank 17, and the recovered water which has been separated from the natural gas hydrate is returned to the water storage tank 17 and to the pressure vessel 20 via this water distribution conduit.

In the second variant embodiment, of which a structural block diagram of the processes thereof is shown in FIG. 5, in the same way as in the case of the FIG. 4 variant embodiment, the recovered water is returned to the generation part 1, but a water cooling part 7 is provided, which cools this recovered water before it is returned to the generation part 1.

In the third variant embodiment, of which a structural block diagram of the processes thereof is shown in FIG. 6, it is arranged for the natural gas which is not used for the generation of natural gas hydrate in the hydrate dewatering part 3 to be conducted to the generation part 1.

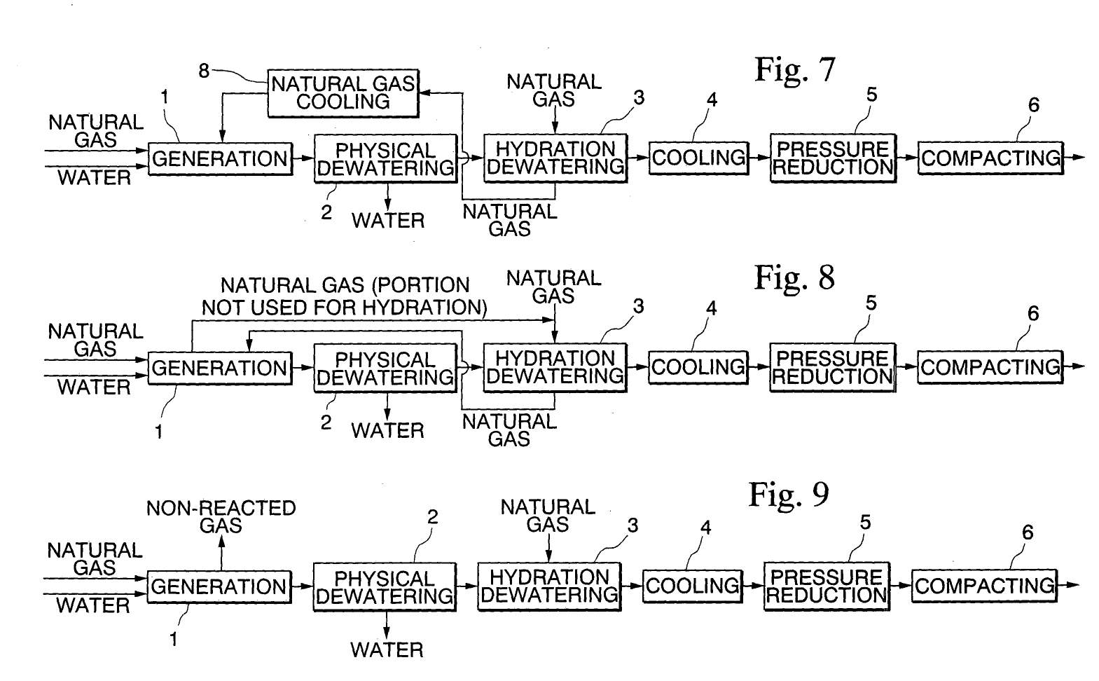

In the fourth variant embodiment, of which a structural block diagram of the processes thereof is shown in FIG. 7, in the same way as in the case of the FIG. 6 variant embodiment, a natural gas cooling part 8 is provided which cools the natural gas before it is conducted to the generation part 1.

It should be noted that not only may this natural gas cooling part 8 be a device which cools the natural gas directly, but also it may be a device which adiabatically expands the natural gas to lower its temperature and subsequently raises the pressure thereof.

Furthermore, it would also be acceptable to provide the natural gas cooling part, not before the natural gas is conducted to the generation part 1, but before it is conducted to the hydrate dewatering part 3; and, indeed, both these possibilities might be implemented jointly.

In the fifth variant embodiment, of which a structural block diagram of the processes thereof is shown in FIG. 8, it is arranged for the natural gas which is not used for generation of natural gas hydrate in the generation part 1 may be conducted to the hydrate dewatering part 3, and for it to be recirculated between the generation part 1 and the hydrate dewatering part 3.

In the sixth variant embodiment, of which a structural block diagram of the processes thereof is shown in FIG. 9, it is arranged for the reaction gas which still remains after generation of the natural gas hydrate in the generation part 1 to be eliminated (to be purged) from the generation part 1.

It should be understood that, if the natural gas is recirculated between the generation part 1 and the hydrate dewatering part 3 as shown in FIG. 8, then it would be acceptable for the construction to be such as to eliminate this unused reaction gas from any point in the gas distribution conduits which make up the recirculation system.

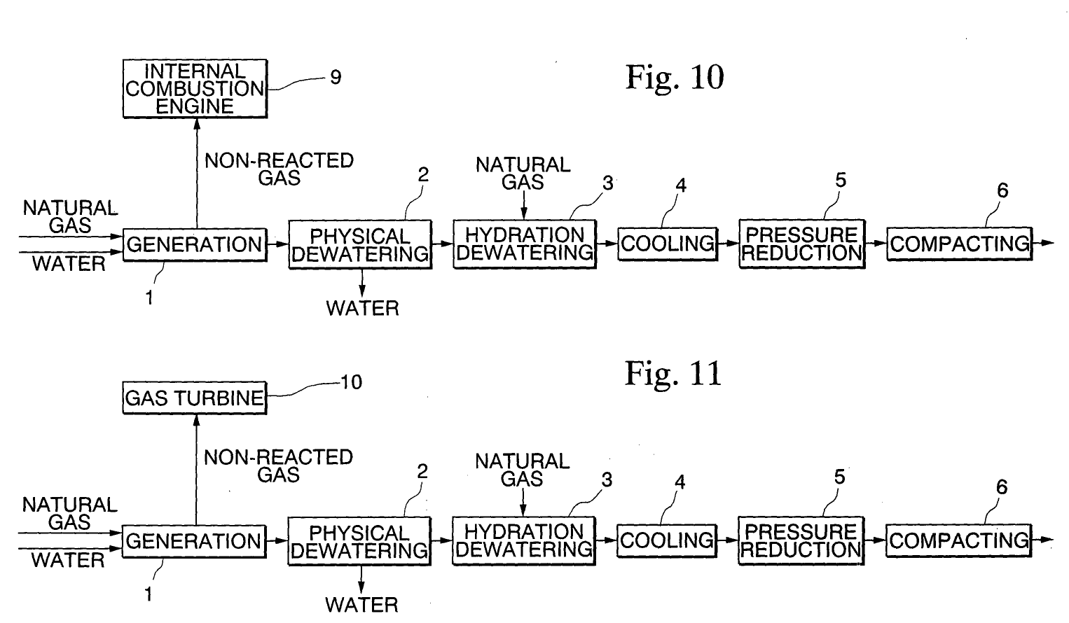

In the seventh variant embodiment, of which a structural block diagram of the processes thereof is shown in FIG. 10, the unused reaction gas is utilized as fuel for an internal combustion engine 9 or a boiler or the like.

In the eighth variant embodiment, of which a structural block diagram of the processes thereof is shown in FIG. 11, the unused reaction gas is utilized as drive gas for a gas turbine 10.

As has been explained above, the screw press type dewatering device according to the present invention can be used in the processes whose structure is given by the block diagrams shown in FIG. 1 and FIGS. 4 through 11; and, of course, it could also be utilized in processes whose structures are specified by combinations thereof.

Furthermore, the scope of application of the screw press type dewatering device according to the present invention is not limited to a natural gas hydrate production system which utilizes a process structure according to such a combination of the various above described process structures; it could also be applied to a production system which utilizes a process which requires dewatering of natural gas hydrate after generation thereof.

Yet further, although in the above explanation the case of natural gas hydrate was described by way of example, in fact the present invention is not limited to this application; it could also be applied to a gas hydrate other than a natural gas hydrate.

It should be understood that the structure of the present invention is not limited to that of the above described embodiments; various alterations may be made to the details and the scope of any particular embodiment, provided that the gist of the present invention is not departed from.

### INDUSTRIAL APPLICABILITY

According to the gas hydrate slurry dewatering device of the present invention as described above, the following beneficial effects are attained.

According to the first aspect of the present invention, since the dewatering device for a gas hydrate slurry is equipped with a slurry dewatering part which is provided in an environment which is maintained at temperature and pressure conditions at which the gas hydrate does not decompose and the water does not freeze, thereby, during dewatering, the gas hydrate is not decomposed, and the water remains liquid just as it is and does not freeze. Accordingly, it is possible to provide a dewatering device for a gas hydrate slurry which can easily perform dewatering of the water in the raw material slurry, and which moreover maintains a high recovery ratio.

According to the second aspect of the present invention, since the dewatering device for a gas hydrate slurry is equipped with a dewatering part within the pressure vessel which is maintained at a temperature and a pressure at which the gas hydrate does not decompose and the water does not freeze, therefore the gas hydrate does not decompose during the dewatering process, and the water in liquid form can easily be subjected to dewatering. Accordingly, it is easily possible to perform dewatering upon the water in the raw material slurry, and also it is possible to provide a dewatering device for a gas hydrate slurry which can maintain a high recovery ratio.

Furthermore, continuous dewatering becomes possible by utilizing a dewatering part of a screw press type, and, by disposing said dewatering part within the pressure vessel, and in particular by utilizing a canned motor and performing the driving thereby, it becomes unnecessary to provide any shaft seal for any axial portion which might pierce through the pressure vessel.

This type of dewatering device is particularly adapted to and suitable for the dewatering of natural gas hydrate, since in this case high pressure conditions are required in order to ensure an environment in which the gas hydrate does not decompose and the water does not freeze, and moreover it is required for leakage to be reliably prevented, since the gas which is to be decomposed is inflammable.

According to the third aspect of the present invention, since the dewatering method for a gas hydrate slurry performs dewatering by supplying the slurry in which the gas hydrate is dispersed in water to a slurry dewatering part which is provided in an environment which is maintained at temperature and pressure conditions at which the gas hydrate does not decompose and the water does not freeze, thereby, during dewatering, the gas hydrate is not decomposed, and the water remains liquid just as it is and does not freeze. Accordingly, it is possible to provide a dewatering method for a gas hydrate slurry which can easily perform dewatering of the water in the raw material slurry, and which moreover maintains a high recovery ratio.

According to the fourth aspect of the present invention, since the dewatering method for a gas hydrate slurry performs dewatering by supplying the slurry in which the gas hydrate is dispersed in water to said dewatering part within the pressure vessel which is maintained at a temperature and a pressure at which the gas hydrate does not decompose and the water does not freeze, therefore the gas hydrate does not decompose during the dewatering process, and the water in liquid form can easily be subjected to dewatering. Accordingly, it is easily possible to perform dewatering upon the water in the raw material slurry, and also it is possible to provide a dewatering method for a gas hydrate slurry which can maintain a high recovery ratio.

Furthermore, continuous dewatering becomes possible by utilizing a dewatering part of a screw press type, and, by disposing said dewatering part within the pressure vessel, and in particular by utilizing a canned motor and performing the driving thereby, it becomes unnecessary to provide any shaft seal for any axial portion which might pierce through the pressure vessel.

This type of dewatering method is particularly adapted to and suitable for the dewatering of natural gas hydrate, since in this case high pressure conditions are required in order to ensure an environment in which the gas hydrate does not decompose and the water does not freeze, and moreover it is required for leakage to be reliably prevented, since the gas which is to be decomposed is inflammable.

1. A dewatering device (12) for a gas hydrate slurry which eliminates water from a slurry in which a gas hydrate is dispersed in water, in which a dewatering part is provided in an environment which is maintained at temperature and pressure conditions at which the gas hydrate does not decompose and the water does not freeze.

2. A dewatering device (12) for a gas hydrate slurry which eliminates water from a slurry in which a gas hydrate is dispersed in water, in which a dewatering part is provided in a pressure vessel (42) which is maintained at a temperature and a pressure at which the gas hydrate does not decompose and the water does not freeze.

3. A dewatering device (12) for a gas hydrate slurry according to claim 2, wherein said dewatering part is a screw press type.

4. A dewatering device (12) for a gas hydrate slurry according to claim 2, wherein a drive section (42) of said dewatering part is provided in said pressure vessel (40).

5. A dewatering device (12) for a gas hydrate slurry according to claim 2, wherein said dewatering part is driven by a canned motor (42).

6. A dewatering device (12) for gas hydrate slurry according to claim 1, wherein said gas hydrate is a natural gas hydrate.

7. A dewatering device (12) for gas hydrate slurry according to claim 2, wherein said gas hydrate is a natural gas hydrate.

8. A dewatering method for gas hydrate slurry which eliminates water from a slurry in which a gas hydrate is dispersed in water, in which said slurry in which a gas hydrate is dispersed in water is supplied to a dewatering part which is provided in an environment which is maintained at temperature and pressure conditions at which the gas hydrate does not decompose and the water does not freeze, and is dewatered thereby.

9. A dewatering method for gas hydrate slurry which eliminates water from a slurry in which a gas hydrate is dispersed in water, in which a dewatering part is provided in a pressure vessel (40) which is maintained at a temperature and a pressure at which the gas hydrate does not decompose and the water does not freeze, and said slurry in which a gas hydrate is dispersed in water is supplied to said dewatering part and is dewatered thereby.

10. A dewatering method for gas hydrate slurry according to claim 9, wherein said dewatering part is a screw press type.

11. A dewatering method for gas hydrate slurry according to claim 9, wherein a drive section (42) of said dewatering part is provided in said pressure vessel (40).

12. A dewatering method for gas hydrate slurry according to claim 9, wherein said dewatering part is driven by a canned motor (42).

13. A dewatering method for gas hydrate slurry according to claim 8, wherein said gas hydrate is a natural gas hydrate.

14. A dewatering method for gas hydrate slurry according to claim 9, wherein said gas hydrate is a natural gas hydrate.
